(19) United States
(12) Patent Application Publication
(10) Pub. No.: US 2025/0307996 A1
(43) Pub. Date: Oct. 2, 2025

(54) IMAGE PROCESSING METHOD FOR REDUCING FLICKERING AND IMAGE PROCESSOR UTILIZING THE SAME

(71) Applicant: NOVATEK Microelectronics Corp., Hsin-Chu (TW)

(72) Inventor: Hsiao-En Chang, Hsinchu County (TW)

(73) Assignee: NOVATEK Microelectronics Corp., Hsin-Chu (TW)

(21) Appl. No.: 18/621,125

(22) Filed: Mar. 29, 2024

(51) Int. Cl. G06T 5/70; G06T 5/20; G06T 7/12; G06T 7/136; G06T 7/246

(52) U.S. Cl. CPC G06T 5/70; G06T 5/20; G06T 7/12; G06T 7/136; G06T 7/246; G06T 2207/10016; G06T 2207/20201

(57) ABSTRACT

An image processing method includes computing N cumulative counts of bright pixels in N binned intervals of an image frame, respectively, and identifying, from a selected range of the N binned intervals, a target binned interval closest to a boundary of the image frame that has a cumulative count of bright pixels exceeding a bin threshold, each binned interval comprising M lines. The method further includes determining whether a line in the target binned interval is in a side area of the image frame according to at least bright pixel counts of a preceding line and a succeeding line in the target binned interval, and selecting from the side area a line adjacent to a central area as a box edge.

### BACKGROUND OF THE INVENTION

### 1. Field of the Invention

The invention related to image processing, and specifically, to an image processing method for reducing flickering and image processor utilizing the same.

### 2. Description of the Prior Art

Image processors employ motion estimation and motion compensation (MEMC) technique to enhance the quality of motion pictures. Typically, during a MEMC process such as MEME frame interpolation, the image processor identifies darker lines near the sides of an input image as the rims, and fills the rims using black pixels to create black borders around a regenerated image.

However, if the sides of the input image are blurred, the clear black borders of the regenerated image may appear inconsistent with the original input image, degrading the picture quality and increasing image flickering along the edges of the images.

### SUMMARY OF THE INVENTION

According to an embodiment of the invention, an image processing method includes computing N cumulative counts of bright pixels in N binned intervals of an image frame, respectively, and identifying, from a selected range of the N binned intervals, a target binned interval closest to a boundary of the image frame that has a cumulative count of bright pixels exceeding a bin threshold, each binned interval comprising M lines, N being an integer greater than 1, M being an integer greater than 2. The method further includes determining whether a line in the target binned interval is in a side area of the image frame according to at least bright pixel counts of a preceding line and a succeeding line in the target binned interval, and selecting from the side area a line adjacent to a central area as a box edge.

According to another embodiment of the invention, an image processor includes a bright pixel counter, a bin selection circuit and a box edge circuit. The bright pixel counter computes N cumulative counts of bright pixels in N binned intervals of an image frame, respectively, each binned interval comprising M lines, N being an integer greater than 1, M being an integer greater than 2. The bin selection circuit is coupled to the bright pixel counter to identify, from the N binned intervals, a target binned interval closest to a boundary of the image frame that has a cumulative count of bright pixels exceeding a bin threshold. The box edge circuit is coupled to the bin selection circuit to determine whether a line in the target binned interval is in a side area of the image frame according to at least bright pixel counts of a preceding line and a succeeding line in the target binned interval, and select from the side area a line adjacent to a central area as a box edge.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an image processor according to an embodiment of the invention.

FIG. 2 is a schematic diagram of vertical binned intervals in an image frame for use by the image processor in FIG. 1.

FIG. 3 is a schematic diagram of horizontal binned intervals in an image frame for use by the image processor in FIG. 1.

FIG. 4 is a flowchart of an image processing method of the image processor in FIG. 1.

FIG. 5 is a schematic diagram of bright pixel counts of selected lines in the target binned interval.

FIG. 6 is a schematic diagram of differences in the bright pixel counts in the target binned interval.

FIG. 7 is a schematic diagram of motion compensation according to an embodiment of the invention.

FIG. 8 is a schematic diagram of the motion compensation circuit in FIG. 1.

### DETAILED DESCRIPTION

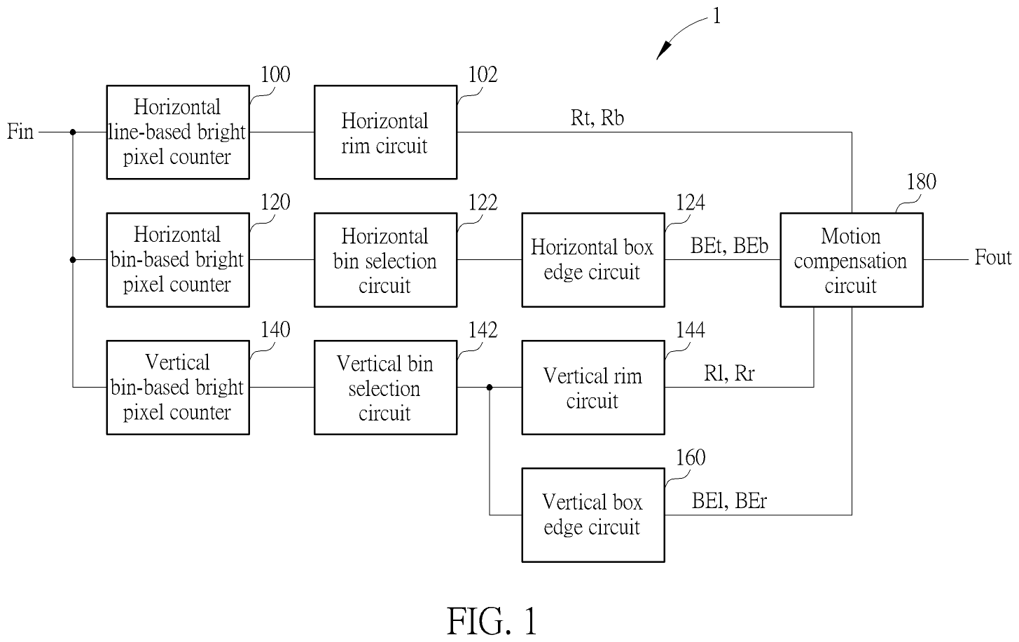

FIG. 1 is a block diagram of an image processor 1 according to an embodiment of the invention. The image processor 1 may receive an image frame Fin from a video source, detect a top rim Rt, a bottom rim Rb, a top box edge BEt, a bottom box edge BEb, a left rim Rl, a right rim Rr, a left box edge BEl, a right box edge BEr from the image frame Fin, generate an image frame Fout according to the rims Rt, Rb, Rl, Rr and the box edges BEt, BEb, BEl, BEr, and perform motion compensation functions such as estimation and motion compensation (MEMC) frame interpolation on consecutive image frames Fout to generate interpolated frames for storage in a memory device and/or display on a display device, thereby reducing image flickering and enhancing the picture quality.

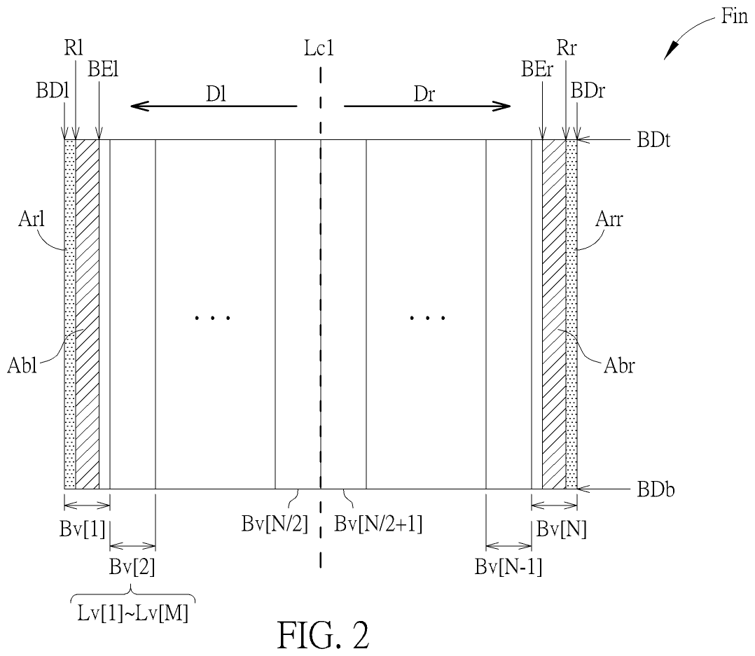

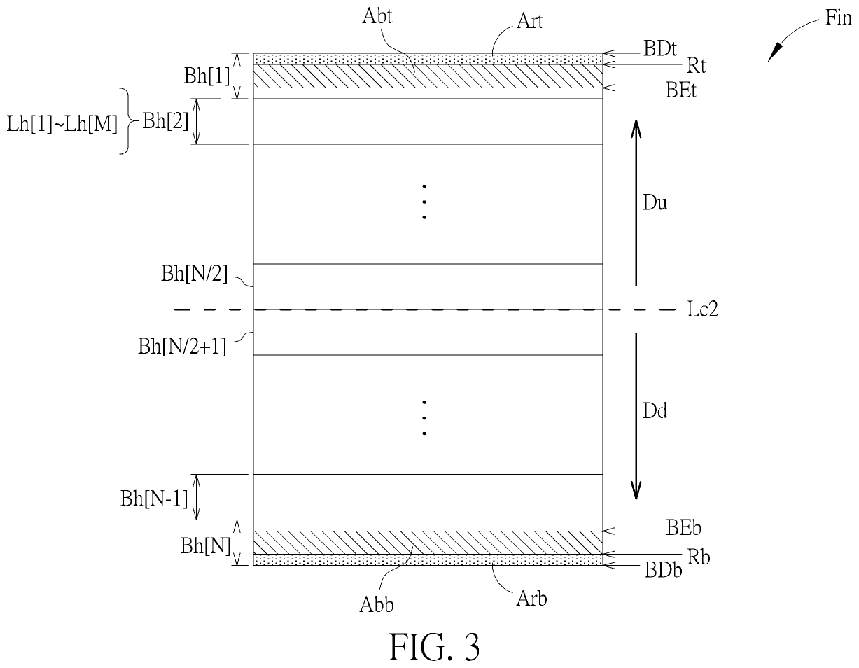

The top rim Rt, the bottom rim Rb, the left box edge BEl and the right box edge BEr may be shown as in FIG. 2, and the left rim Rl, the right rim Rr, the top box edge BEt and the bottom box edge BEb may be shown as in FIG. 3. In FIG. 2, the input image Fin is pillarboxed by a left side area and a right side area, with the left side area including a rim area Arl and a blurry area Abl, and the right side area including a rim area Arr and a blurry area Abr. The rim area Arl may be defined by a left boundary BDI, the left rim Rl, a top boundary BDt and a bottom boundary BDb, and the blurry area Abl may be defined by the left rim Rl, the left box edge BEl, the top boundary BDt and the bottom boundary BDb. The rim area Arr may be defined by a right boundary BDr, the right rim Rr, the top boundary BDt and the bottom boundary BDb, and the blurry area Abr may be defined by the right rim Rr, the right box edge BEr, the top boundary BDt and the bottom boundary BDb. In FIG. 3, the input image Fin is letterboxed by a top side area and a bottom side area, with the top side area including a rim area Art and a blurry area Abt, and the bottom side area including a rim area Arb and a blurry area Abb. The rim area Art may be defined by the top boundary BDt, the top rim Rt, the left boundary BDl and the right boundary BDr, and the blurry area Abt may be defined by the top rim Rt, the top box edge BEt, the left boundary BDl and the right boundary BDr. The rim area Arb may be defined by the bottom boundary BDb, the bottom rim Rb, the left boundary BDl and the right boundary BDr, and the blurry area Abb may be defined by the bottom rim Rb, the bottom box edge BEb, the left boundary BDl and the right boundary BDr. While FIGS. 2 and 3 show a pillarboxed image and a letterboxed image, respectively, the image frame Fin may be pillarboxed and letterboxed simultaneously. FIGS. 2 and 3 will be discussed in more detail in the subsequent paragraphs.

In FIG. 1, the image processor 1 may include a horizontal line-based bright pixel counter 100 and a horizontal rim circuit 102 to detect the top rim Rt and the bottom rim Rb. The horizontal line-based bright pixel counter 100 and the horizontal rim circuit 102 are coupled to each other. The horizontal line-based bright pixel counter 100 may receive the image frame Fin, and accumulate a bright pixel count for each horizontal line (also referred to as row) in the image frame Fin. For example, the resolution of the image frame Fin may be 3840×2160, i.e., 2160 horizontal lines, with each horizontal line containing 3840 pixels. The horizontal line-based bright pixel counter 100 may count the quantity of bright pixels in each horizontal line, resulting in 2160 bright pixel counts. If the brightness level of a pixel in a horizontal line exceeds a brightness threshold, the bright pixel count for the horizontal line is incremented by 1. If the brightness level of the pixel in the horizontal line is less than the brightness threshold, the bright pixel count for the horizontal line remains unchanged. The horizontal line-based bright pixel counter 100 may store the bright pixel count of each horizontal line in a local memory device.

To determine the positions of the top rim Rt and the bottom rim Rb, the image frame Fin is divided into an upper half and a lower half. The horizontal rim circuit 102 may search for the top rim Rt from the upper half and the bottom rim Rb from the lower half. In FIG. 3, the horizontal rim circuit 102 may start the search for the top rim Rt from a center line Lc2 of the image frame Fin and progresses the search in an upward direction Du until the top rim Rt is located. The horizontal rim circuit 102 may compare the bright pixel count of each horizontal line with a line threshold to identify the top rim Rt. The last horizontal line where the bright pixel count exceeds the line threshold is identified as the top rim Rt. Similarly, the horizontal rim circuit 102 may start the search for the bottom rim Rb from the center line Lc2 of the image frame Fin and progresses the search in a downward direction Dd until the bottom rim Rb is located. The horizontal rim circuit 102 may compare the bright pixel count of each horizontal line with a line threshold to identify the bottom rim Rb. The last line where the bright pixel count exceeds the line threshold is identified as the bottom rim Rb. In this manner, the horizontal line-based bright pixel counter 100 and the horizontal rim circuit 102 perform precise detection of the top rim Rt and the bottom rim Rb based on the distribution of bright pixels in the image frame Fin.

Further, the image processor 1 may include a horizontal bin-based bright pixel counter 120, a horizontal bin selection circuit 122, and a horizontal box edge circuit 124 to detect the top box edge BEt and the bottom box edge BEb. The horizontal bin-based bright pixel counter 120, the horizontal bin selection circuit 122, and the horizontal box edge circuit 124 are sequentially coupled. The image frame Fin may be divided into N horizontal binned intervals, each horizontal binned interval containing M horizontal lines, N being an integer greater than 1, M being an integer greater than 2. In FIG. 3, the image frame Fin is divided into horizontal binned intervals Bh[1] to Bh[N], each horizontal binned interval containing horizontal lines Lh[1] to Lh[M]. For example, if the image frame Fin includes 2160 horizontal lines, N=72, and M=30, the image frame Fin may be divided into 72 horizontal binned intervals, each horizontal binned interval containing 30 horizontal lines. The horizontal bin-based bright pixel counter 120 may compute cumulative counts of bright pixels for each horizontal binned interval. The horizontal bin selection circuit 122 may analyze the cumulative counts of bright pixels to select a target binned interval. The horizontal box edge circuit 124 may identify the top box edge BEt or the bottom box edge BEb from the target horizontal binned interval.

Further, the image processor 1 may include a vertical bin-based bright pixel counter 140, a vertical bin selection circuit 142, and a vertical rim circuit 144 to detect the left rim Rl and the right rim Rr. The vertical bin-based bright pixel counter 140, the vertical bin selection circuit 142, and the vertical rim circuit 144 are sequentially coupled. The image frame Fin may be divided into N vertical binned intervals, each vertical binned interval containing M vertical lines (also referred to as columns), N being an integer greater than 1, M being an integer greater than 2. In FIG. 2, the image frame Fin is divided into vertical binned intervals Bv[1] to Bv[N], each vertical binned interval containing vertical lines Lv[1] to Lv[M]. N, M in FIG. 2 may be identical to or different from N, M in FIG. 3. For example, if the image frame Fin includes 3840 vertical lines, N=120, and M=32, the image frame Fin may be divided into 120 vertical binned intervals, each vertical binned interval containing 32 vertical lines. The vertical bin-based bright pixel counter 140 may compute cumulative counts of bright pixels for each vertical binned interval. The vertical bin selection circuit 142 may analyze the cumulative counts of bright pixels to select a target vertical binned interval. The vertical rim circuit 144 may identify the left rim Rl or the right rim Rr from the target vertical binned interval. In some embodiments, the vertical rim circuit 144 may identify, from the target vertical binned interval, a line closest to a boundary of the image frame that has a bright pixel count exceeding a line threshold as the left rim Rl or the right rim Rr. For example, if the vertical binned interval Bv[1] is the target vertical binned interval, and in the vertical binned interval Bv[1], the vertical lines Lv[1] and Lv[2] both exceed the brightness threshold and the vertical lines Lv[3] to Lv[M] all are less than the line threshold, since the vertical line Lv[3] is the closest one to the left boundary BDI, the vertical rim circuit 144 may identify the vertical line Lv[3] of the vertical binned interval Bv[1] as the left rim Rl. If the vertical binned interval Bv[N] is the target vertical binned interval, and in the vertical binned interval Bv[N], the vertical lines Lv[1] to Lv[M−2] are all less than the line threshold and the vertical lines Lv[M−1] and Lv[M] both exceed the brightness threshold and, since the vertical line Lv[M−2] is the closest one to the right boundary BDr, the vertical rim circuit 144 may identify the vertical line Lv[M−2] of the vertical binned interval Bv[N] as the right rim Rr. In this manner, the vertical rim circuit 144 may accurately locate the left rim Rl and the right rim Rr of image frame Fin based on the bright pixel count criterion.

Further, the image processor 1 may include a vertical box edge circuit 160 to detect the left box edge BEl and the right box edge BEr. The vertical box edge circuit 160 is coupled to the vertical bin selection circuit 142 to identify the left box edge BEl or the right box edge BEr from the target vertical binned interval.

Furthermore, the image processor 1 may include a motion compensation circuit 180 coupled to the horizontal rim circuit 102, the horizontal box edge circuit 124, the vertical rim circuit 144, and the vertical box edge circuit 160. The motion compensation circuit 180 may generate the image frame Fout according to the rims Rt, Rb, Rl, Rr and the box edges BEt, BEb, BEl, BEr.

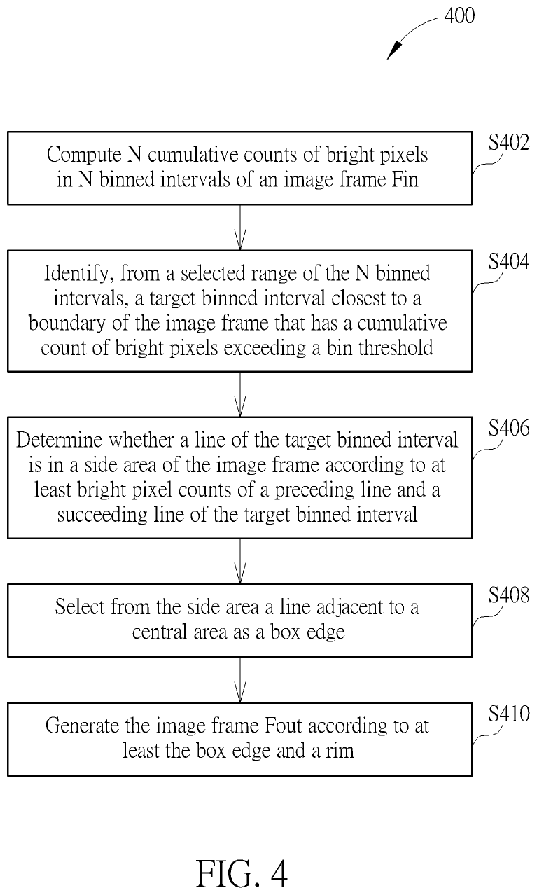

FIG. 4 is a flowchart of an image processing method 400 of the image processor 1. The method 400 includes Steps S402 to S410 to detect a box edge from the image frame Fin and generate the image frame Fout accordingly. Any reasonable step change or adjustment is within the scope of the present disclosure. Steps S402 to S410 are detailed as follows:
Step S402: Compute cumulative counts of bright pixels in N binned intervals of the image frame Fin;
Step S404: Identify, from a selected range of the N binned intervals, a target binned interval closest to a boundary of the image frame that has a cumulative count of bright pixels exceeding a bin threshold;
Step S406: Determine whether a line in the target binned interval is in a side area of the image frame according to at least bright pixel counts of a preceding line and a succeeding line in the target binned interval;
Step S408: Select from the side area a line adjacent to a central area as a box edge;
Step S410: Generate the image frame Fout according to at least the box edge and a rim.

Steps S402 to S408 may be applied to detect the top box edge BEt and the bottom box edge BEb, and the details will be explained with reference to FIGS. 1 and 3. In Step S402, the horizontal bin-based bright pixel counter 120 receives the image frame Fin, accumulates a bright pixel count of pixels having brightness levels exceeding a brightness threshold for each line of a horizontal binned interval, and sums the bright pixel counts of M lines in the horizontal binned interval to generate a cumulative count of bright pixels in the horizontal binned interval, thereby computing the N cumulative counts of bright pixels in the horizontal binned intervals Bh[1] to Bh[N]. If the brightness level of a pixel in a horizontal binned interval exceeds the brightness threshold, the horizontal bin-based bright pixel counter 120 may increment the cumulative count of bright pixels in the horizontal binned interval by 1. If the brightness level of the bright pixel in the horizontal binned interval is less than the brightness threshold, the horizontal bin-based bright pixel counter 120 may hold the cumulative count of bright pixels in the horizontal binned unchanged. The horizontal bin-based bright pixel counter 120 may store the cumulative counts of bright pixels in the horizontal binned intervals Bh[1] to Bh[N] in a local memory device. The horizontal bin-based bright pixel counter 120 and the horizontal line-based bright pixel counter 100 may adopt, but are not limit to, identical brightness thresholds. In some embodiments, the horizontal bin-based bright pixel counter 120 and the horizontal line-based bright pixel counter 100 may adopt different brightness thresholds.

The positions of the target binned intervals in the upper half and the lower half of the image frame Fin are then determined. In Step S404, the horizontal bin selection circuit 122 identifies, from the horizontal binned intervals Bh[1] to Bh[N/2] in the upper half of the input frame Fin, a target binned interval closest to the top boundary BDt that has a cumulative count of bright pixels exceeding a bin threshold. For example, if the horizontal binned intervals Bh[1] to Bh[N/2] all exceed the bin threshold, since the horizontal binned interval Bh[1] is the closest one to the top boundary BDt, the horizontal bin selection circuit 122 may identify the horizontal binned interval Bh[1] as the target binned interval. The target binned interval may contain the top box edge BEt. While the specific range of the horizontal binned intervals Bh[1] to Bh[N/2] is given in the embodiment, it would be apparent for those skilled in the art that other ranges of the horizontal binned intervals may be adopted to find the target binned interval to satisfy the design requirements. The horizontal bin selection circuit 122 may start the search for the target binned interval from the horizontal binned interval Bh[N/2] and progress the search in the upward direction Du (towards Bh[1]) until the target binned interval is located. Alternatively, the horizontal bin selection circuit 122 may start the search for the target binned interval from the horizontal binned interval Bh[1] and progress the search in the downward direction (towards Bh[N/2]) until the target binned interval is located.

Similarly, the horizontal bin selection circuit 122 may identify, from the horizontal binned intervals Bh[N/2+1] to Bh[N] in the lower half of the input frame Fin, a target binned interval closest to the bottom boundary BDb that has a cumulative count of bright pixels exceeding the bin threshold. For example, if the horizontal binned intervals Bh[N/2+1] to Bh[N] all exceed the bin threshold, since the horizontal binned interval Bh[N] is the closest one to the bottom boundary BDb, the horizontal bin selection circuit 122 may identify the horizontal binned interval Bh[N] as the target binned interval. The target binned interval may contain the bottom box edge BEb. The searching order may be similar to the search in the upper half of the input frame Fin and will not be repeated here for brevity.

Next, the positions of the top box edge BEt and the bottom box edge BEb are determined. In Step S406, the horizontal box edge circuit 124 determines whether a horizontal line Lh[i] in the target binned interval Bh[1] in the upper half of the image frame Fin is in a side area of the image frame Fin according to at least bright pixel counts of a preceding line Lh[i−1] and a succeeding line Lh[i+1] in the target binned interval Bh[1], i being an integer ranging from 1 to M. In some embodiments, the horizontal box edge circuit 124 may compute a difference in the bright pixel counts between the preceding line Lh[i−1] and the succeeding line Lh[i+1] of the target binned interval Bh[1], and if the difference in the bright pixel counts is less than a count difference threshold, identify the horizontal line Lh[i] of the target binned interval Bh[1] as in the side area of the image frame Fin. On the other hand, if the difference in the bright pixel counts exceeds the count difference threshold, the horizontal box edge circuit 124 may identify the horizontal line Lh[i] of the target binned interval Bh[1] as in the central area of the image frame Fin. In Step S408, the horizontal box edge circuit 124 selects from the side area a horizontal line adjacent to a central area as the top box edge BEt. In some embodiments, if an absolute difference of positions between the top box edge BEt and the top rim Rt exceeds a position difference threshold, the horizontal box edge circuit 124 may further update the top box edge BEt according to the top rim Rt and a position difference threshold. For example, consider a case where the position difference threshold is set to 6, if the positions of the top box edge BEt and the top rim Rt are different by 10 horizontal lines, the horizontal box edge circuit 124 may update the position of the top box edge BEt to 6 lines down from the top rim Rt.

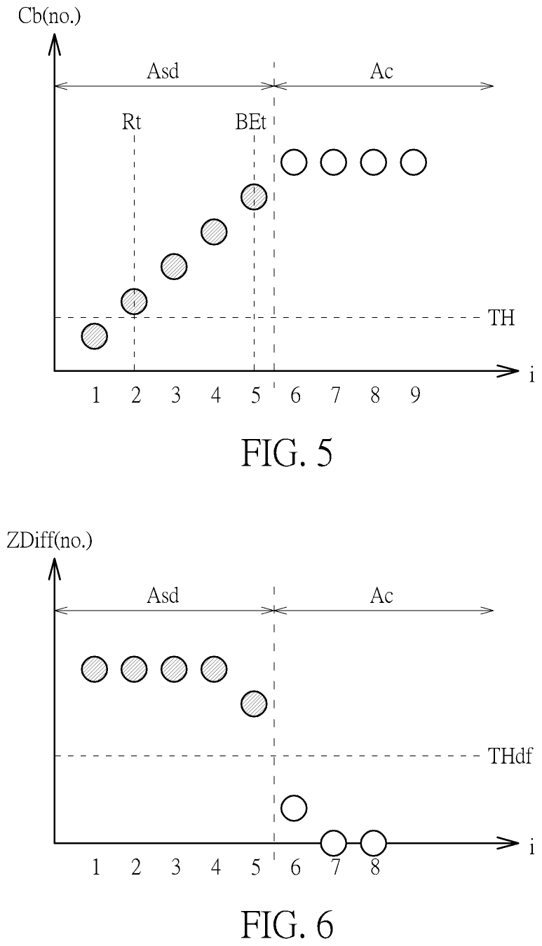

Steps S406 and S408 can be exemplified with reference to FIGS. 5 and 6. FIG. 5 is a schematic diagram of bright pixel counts of selected lines in the target binned interval, where the x-axis represents the index i of lines in the target binned interval, the y-axis represents the bright pixel counts Cb of the lines. FIG. 6 is a schematic diagram of differences in the bright pixel counts in the target binned interval, where the x-axis represents the index i of the lines in the target binned interval, the y-axis represents the differences ZDiff in the bright pixel counts. In FIG. 5, the bright pixel counts of the lines Lh[1] to Lh[5] show constant increases, the bright pixel count of the lines Lh[6] rises at a reduced pace, and the bright pixel counts of the lines Lh[7] to Lh[9] stay substantially unchanged. Thus in FIG. 6, the differences ZDiff in the bright pixel counts of the lines Lh[1] to Lh[4] are constant, the differences ZDiff in the bright pixel counts of the lines Lh[5] and Lh[6] decrease, and the differences ZDiff in the bright pixel counts of the lines Lh[7] and Lh[8] remains unchanged at 0. In FIG. 6, the differences ZDiff in the bright pixel counts of the lines Lh[1] to Lh[5] are above the count difference threshold THdf, and thus the lines Lh[1] to Lh[5] are located in the side area Asd of the image frame Fin. The differences ZDiff in the bright pixel counts of the lines Lh[6] to Lh[8] are below the count difference threshold THdf, and thus the lines Lh[6] to Lh[8] are located in the central area Ac of the image frame Fin. Further, in FIG. 5, since the line Lh[2] is the last horizontal line where the bright pixel count exceeds the line threshold TH, the line Lh[2] is identified as the top rim Rt. Since the absolute difference of positions between the line Lh[5] (top box edge BEt) and the line Lh[2] (top rim Rt) is less than 6 (the position difference threshold), the top box edge BEt may remain at the line Lh[5]. Therefore, the horizontal box edge circuit 124 selects from the side area Asd the horizontal line Lh[5] immediately adjacent to the central area Ac as the top box edge BEt.

Similarly, for detecting the bottom box edge BEb, the horizontal box edge circuit 124 may determine whether a horizontal line Lh[i] in the target binned interval Bh[N] in the lower half of the image frame Fin is in a side area of the image frame Fin according to at least bright pixel counts of a preceding line Lh[i−1] and a succeeding line Lh[i+1] in the target binned interval Bh[N]. In some embodiments, the horizontal box edge circuit 124 may compute a difference in the bright pixel counts between the preceding line Lh[i−1] and the succeeding line Lh[i+1] of the target binned interval Bh[N], and if the difference in the bright pixel counts is less than the count difference threshold, identify the horizontal line Lh[i] of the target binned interval Bh[N] as in the side area of the image frame Fin. On the other hand, if the difference in the bright pixel counts exceeds the count difference threshold, the horizontal box edge circuit 124 may identify the horizontal line Lh[i] of the target binned interval Bh[N] as in the central area of the image frame Fin. In Step S408, the horizontal box edge circuit 124 selects from the side area a horizontal line adjacent to the central area as the bottom box edge BEb. In some embodiments, if an absolute difference of positions between the bottom box edge BEb and the bottom rim Rb exceeds a position difference threshold, the horizontal box edge circuit 124 may further update the bottom box edge BEb according to the bottom rim Rb and the position difference threshold. For example, consider a case where the position difference threshold is set to 6, if the positions of the bottom box edge BEb and the bottom rim Rb are different by 10 horizontal lines, the horizontal box edge circuit 124 may update the position of the bottom box edge BEb to 6 lines up from the bottom rim Rb.

Likewise, Steps S402 to S408 may be applied to detect the left box edge BEl and the bottom box edge BEb, and the details will be explained with reference to FIGS. 1 and 2. In Step S402, the vertical bin-based bright pixel counter 140 receives the image frame Fin, accumulates a bright pixel count of pixels having brightness levels exceeding a brightness threshold for each line of a vertical binned interval, and sums the bright pixel counts of M lines in the vertical binned interval to generate a cumulative count of bright pixels in the vertical binned interval, thereby computing the N cumulative counts of bright pixels in the vertical binned intervals Bv[1] to Bv[N]. If the brightness level of a pixel in a vertical binned interval exceeds the brightness threshold, the vertical bin-based bright pixel counter 140 may increment the cumulative count of bright pixels in the vertical binned interval by 1. If the brightness level of the pixel in the vertical binned interval is less than the brightness threshold, the vertical bin-based bright pixel counter 140 may hold the cumulative count of bright pixels in the vertical binned interval unchanged. The vertical bin-based bright pixel counter 140 may store the cumulative counts of bright pixels in the vertical binned intervals Bv[1] to Bv[N] in a local memory device.

The positions of the target binned intervals in the left half and the right half of the image frame Fin are then determined. In Step S404, the vertical bin selection circuit 142 identifies, from the vertical binned intervals Bv[1] to Bv[N/2] in the left half of the input frame Fin, a target binned interval closest to the left boundary BDl that has a cumulative count of bright pixels exceeding a bin threshold. For example, if the vertical binned intervals Bv[1] to Bv[N/2] all exceed the bin threshold, since the vertical binned interval Bv[1] is the closest one to the left boundary BDI, The vertical bin selection circuit 142 may identify the vertical binned interval Bv[1] as the target binned interval. The target binned interval may contain the left box edge BEl. While the specific range of the vertical binned intervals Bv[1] to Bv[N/2] is given in the embodiment, it would be apparent for those skilled in the art that other ranges of the vertical binned intervals may be adopted to find the target binned interval to satisfy the design requirements. The vertical bin selection circuit 142 may start the search for the target binned interval from the vertical binned interval Bv[N/2] and progress the search in the leftward direction Dl (towards Bv[1]) until the target binned interval is located. Alternatively, The vertical bin selection circuit 142 may start the search for the target binned interval from the vertical binned interval Bv[1] and progress the search in the downward direction (towards Bv[N/2]) until the target binned interval is located.

Similarly, the vertical bin selection circuit 142 may identify, from the vertical binned intervals Bv[N/2+1] to Bv[N] in the right half of the input frame Fin, a target binned interval closest to the right boundary BDr that has a cumulative count of bright pixels exceeding the bin threshold. For example, if the vertical binned intervals Bv[N/2+1] to Bv[N] all exceed the bin threshold, since the vertical binned interval Bv[N] is the closest one to the right boundary BDr, the vertical bin selection circuit 142 may identify the vertical binned interval Bv[N] as the target binned interval. The target binned interval may contain the right box edge BEr. The searching order may be similar to the search in the left half of the input frame Fin and will not be repeated here for brevity.

Next, the positions of the left box edge BEl and the right box edge BEr are determined. In Step S406, the vertical box edge circuit 160 determines whether a vertical line Lv[i] in the target binned interval Bv[1] in the left half of the image frame Fin is in a side area of the image frame Fin according to at least bright pixel counts of a preceding line Lv[i−1] and a succeeding line Lv[i+1] in the target binned interval Bv[1], i being an integer ranging from 1 to M. In some embodiments, the vertical box edge circuit 160 may compute a difference in the bright pixel counts between the preceding line Lv[i−1] and the succeeding line Lv[i+1] of the target binned interval Bv[1], and if the difference in the bright pixel counts is less than a count difference threshold, identify the vertical line Lv[i] of the target binned interval Bv[1] as in the side area of the image frame Fin. On the other hand, if the difference in the bright pixel counts exceeds the count difference threshold, the vertical box edge circuit 160 may identify the vertical line Lv[i] of the target binned interval Bv[1] as in the central area of the image frame Fin. In Step S408, the vertical box edge circuit 160 selects from the side area a vertical line adjacent to a central area as the left box edge BEl. In some embodiments, if an absolute difference of positions between the left box edge BEl and the left rim Rl exceeds a position difference threshold, the vertical box edge circuit 160 may further update the left box edge BEl according to the left rim Rl and a position difference threshold. For example, consider a case where the position difference threshold is set to 6, if the positions of the left box edge BEl and the left rim Rl are different by 10 vertical lines, the vertical box edge circuit 160 may update the position of the left box edge BEl to 6 lines to the right of the left rim Rl.

Similarly, for detecting the right box edge BEr, the vertical box edge circuit 160 may determine whether a vertical line Lv[i] in the target binned interval Bv[N] in the right half of the image frame Fin is in a side area of the image frame Fin according to at least bright pixel counts of a preceding line Lv[i−1] and a succeeding line Lv[i+1] in the target binned interval Bv[N]. In some embodiments, the vertical box edge circuit 160 may compute a difference in the bright pixel counts between the preceding line Lv[i−1] and the succeeding line Lv[i+1] of the target binned interval Bv[N], and if the difference in the bright pixel counts is less than the count difference threshold, identify the vertical line Lv[i] of the target binned interval Bv[N] as in the side area of the image frame Fin. On the other hand, if the difference in the bright pixel counts exceeds the count difference threshold, the vertical box edge circuit 160 may identify the vertical line Lv[i] of the target binned interval Bv[N] as in the central area of the image frame Fin. In Step S408, the vertical box edge circuit 160 selects from the side area a vertical line adjacent to the central area as the right box edge BEr. In some embodiments, if an absolute difference of positions between the right box edge BEr and the right rim Rr exceeds a position difference threshold, the vertical box edge circuit 160 may further update the right box edge BEr according to the right rim Rr and the position difference threshold. For example, consider a case where the position difference threshold is set to 6, if the positions of the right box edge BEr and the right rim Rr are different by 10 vertical lines, the vertical box edge circuit 160 may update the position of the right box edge BEr to 6 lines to the left of the right rim Rr.

In Step S410, the motion compensation circuit 180 generates the image frame Fout according to the rims Rt, Rb, RI, Rr and the box edges BEt, BEb, BEl, BEr, and perform MEMC functions such as frame interposition on the consecutive image frames Fout to generate motion compensated frames. The motion compensated frames may be interpolated frames interpolating between 2 consecutive image frames Fin, being stored in a memory device and/or displayed on a display device. The motion compensation circuit 180 may process pixels within the areas between the rims Rt, Rb, Rl, Rr and the respective box edges BEt, BEb, BEl, BEr, smoothly transitioning the pixels in the area from solid black pixels to actual pixel data, reducing the disparity between the image frames Fin and the interpolated frames, thereby reducing image flickering, enhancing the video quality, and improving the user experience. If a pixel is located between the rim and a boundary of the side area, the motion compensation circuit 180 may set pixel data of the pixel in image frame Fout to minimum brightness data (also referred to as ZERO data). The minimum brightness data may represent absolute blackness, and may be represented by a brightness level “0”. If a pixel is located between the box edge and an intermediate line between the box edge and the rim, the motion compensation circuit 180 may generate pixel data of the pixel in the image frame Fout according to pixel data of the pixel in the image frame Fin. If a pixel is located between the intermediate line and the rim, the motion compensation circuit 180 may generate pixel data of the pixel in image frame Fout according to a weighted sum of pixel data of the pixel in the image frame Fin and minimum brightness data.

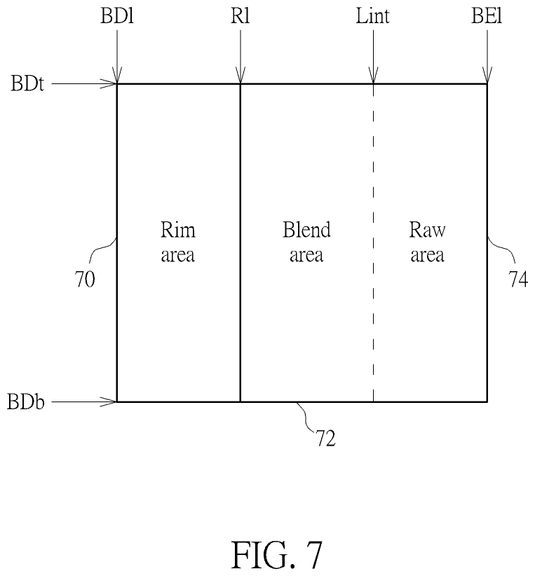

FIG. 7 is a schematic diagram of motion compensation according to an embodiment of the invention. In FIG. 7, the side area is divided into a rim area 70, a blend area 72 and a raw area 74. The rim area 70 may be defined by the left boundary BDI, the top boundary BDt, the left rim Rl, and the bottom boundary BDb. If a pixel lies in the rim area 70 between the left boundary BDl and the left rim Rl, the motion compensation circuit 180 may set the pixel data of that pixel in the image frame Fout to minimum brightness data, resulting in a solid black rim in the rim area 70 of the image frame Fout.

The raw area 74 may be defined by an intermediate line Lint between the left box edge BEl and the left rim Rl, the top boundary BDt, the left box edge BEl, and the bottom boundary BDb. If a pixel lies in the raw area 74 between the intermediate line Lint and the left box edge BEl, the motion compensation circuit 180 may generate pixel data of the pixel in the image frame Fout according to pixel data of the pixel in the image frame Fin. In some embodiments, the motion compensation circuit 180 may set the pixel data of the pixel in the raw area 74 of the image frame Fout to the pixel data of the corresponding pixel in the image frame Fin.

The blend area 72 may be defined by the left rim Rl, the top boundary BDt, the intermediate line Lint, and the bottom boundary BDb. If a pixel lies in the blend area 72 between the left rim Rl and the intermediate line Lint, the motion compensation circuit 180 may compute the respective weights of the minimum brightness data and the pixel in the image frame Fin according to the brightness information and the stillness information of the pixel in the image frame Fin, and generate pixel data of the pixel in the image frame Fout according to a weighted sum of pixel data of the pixel in the image frame Fin and the minimum brightness data. In some embodiments, the weight of the minimum brightness data may be positively correlated to the stillness information and/or negatively correlated to the brightness information. The stillness information may be the differences ZDiff in the bright pixel counts for detecting the positions of the box edges. That is, when a pixel is stiller (i.e., less motion) and/or darker (i.e., less bright), the weight of the minimum brightness data becomes larger. The weight of the pixel in the image frame Fin may be negatively correlated to the stillness information and/or positively correlated to the brightness information. That is, when a pixel exhibits greater movement (i.e., more motion) and/or brighter (i.e., higher brightness), the weight of the pixel becomes larger. The respective weights of the minimum brightness data and the pixel data generating each pixel in the image frame Fout are complementary. When the weight of one of the minimum brightness data and the pixel data increases, the weight of the other one would decrease. For example, the sum of the weight of the minimum brightness data and the weight of pixel data may be 1. If the weight for the minimum brightness data is 0.6, then the weight for the pixel data is 0.4. In another example, if the weights of the minimum brightness data for the blend area 72 gradually decreases from 1 at the left edge R1 to 0 at the intermediate line Lint, the corresponding weights for the pixel data will gradually increase from 0 to 1, thereby smoothly transitioning the pixels in the blend area 72 from the solid black in the rim area 70 to the original pixel data in the raw area 74, reducing image flickering, enhancing the video quality, and improving the user experience.

The rim area 70, the blend area 72 and the raw area 74 are processed separately to allow for a smooth transition from the solid black rim to the original pixel data without generating clear rims in the image frame Fout, and as a consequence, the regenerated frames may appear consistent with the original image frames Fin, thereby reducing image flickering along the edges of the images while enhancing the picture quality.

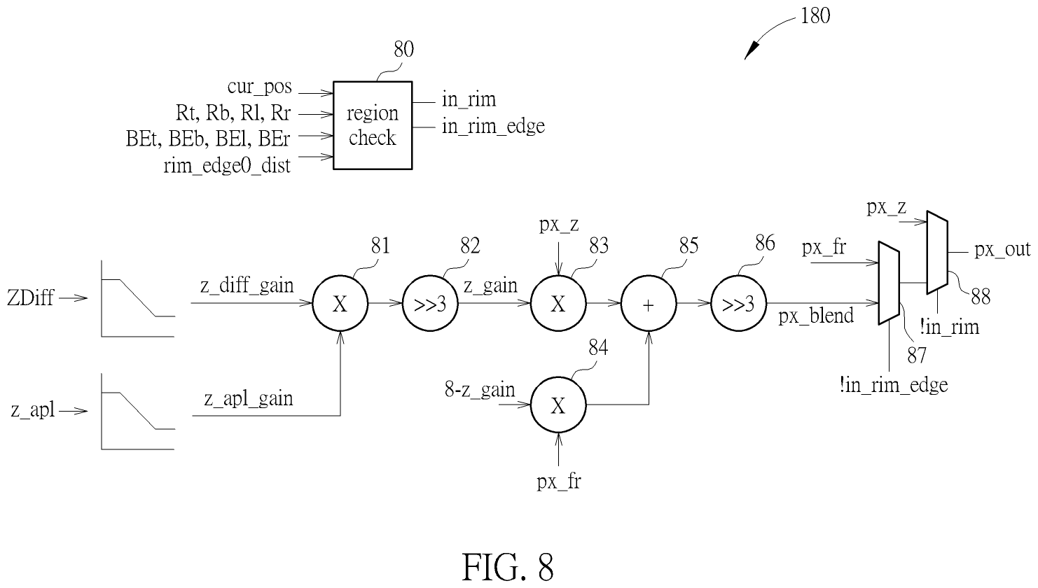

FIG. 8 is a schematic diagram of the motion compensation circuit 180. The motion compensation circuit 180 may include a region check circuit 80, a multiplier 81, a bit shifter 82, multipliers 83 and 84, an adder 85, a bit shifter 86, and multiplexers 87 and 88. The region check circuit 80 may receive a current pixel position cur_pos, positions of the rims Rt, Rb, Rl, Rr, positions of the box edges BEt, BEb, BEl, BEr, and a distance rim_edge0_dist to generate signals in_rim and in_rim_edge. The current pixel position cur_pos may be the position of a current pixel in (x, y) coordinates. The distance rim_edge0_dist may be a distance from a rim to a corresponding box edge. For example, distance rim_edge0_dist may be a distance from the top rim Rt to the top box edge BEt. The signal in_rim may be set to Logic “0” if the pixel lies at the rim area 70, and to Logic “1” if the pixel lies outside the rim area 70. The signal in_rim_edge may be set to Logic “0” if the pixel lies at the blend area 72, and to Logic “1” if the pixel lies outside the blend area 72.

The multiplier 81 may receive a stillness gain signal z_diff_gain and a brightness gain signal z_apl_gain to generate a gain product of the stillness gain signal z_diff_gain and the brightness gain signal z_apl_gain. The stillness gain signal z_diff_gain contains the stillness information, and the brightness gain signal z_apl_gain contains the brightness information. The respective maximum values of the stillness gain signal z_diff_gain and the brightness gain signal z_apl_gain may be 3. The bit shifter 82 may perform a 3-bit right shift operation to divide the gain product by 8, generating a minimum brightness data gain z_gain. The multiplier 83 may multiply the minimum brightness data by the minimum brightness data gain z_gain to generate a minimum brightness data product. The multiplier 84 may multiply pixel data px_fr by the pixel gain (8−z_gain) to generate a pixel data product, wherein pixel data px_fr is the pixel data of a pixel in a current image frame or a previous image frame. The adder 85 may add the minimum brightness data product and the pixel data product to generate blended data. The bit shifter 86 may perform another 3-bit right shift operation to divide the blend data by 8, resulting in data px_blend.

The signal (!in_rim_edge) is the inverse of the signal in_rim_edge, and the signal (!in_rim) is the inverse of the signal in_rim. The multiplexer 87 may select the pixel data px_fr as the output if the signal (!in_rim_edge)=Logic “1”; and select the data px_blend as the output as the output if the signal (!in_rim_edge)=Logic “0”. The multiplexer 88 may select the minimum brightness data px_z as output pixel data px_out if the signal (!in_rim)=Logic “1”; and select the output of the multiplexer 87 as the output pixel data px_out if the signal (!in_rim)=Logic “0”.

Accordingly, the embodiments in FIGS. 1 to 8 identify the rims and the box edges from the image frames Fin to generate a smooth transition from the solid black rim to the original pixel data without forming clear rims, thereby reducing image flickering along the edges of the images and enhancing the picture quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method comprising:
computing N cumulative counts of bright pixels in N binned intervals of an image frame, respectively, each binned interval comprising M lines, N being an integer greater than 1, M being an integer greater than 2;
identifying, from a selected range of the N binned intervals, a target binned interval closest to a boundary of the image frame that has a cumulative count of bright pixels exceeding a bin threshold;
determining whether a line in the target binned interval is in a side area of the image frame according to at least bright pixel counts of a preceding line and a succeeding line in the target binned interval; and
selecting from the side area a line adjacent to a central area as a box edge.

2. The image processing method of claim 1, wherein computing the N cumulative counts of bright pixels in the N binned intervals of the image frame comprises:
accumulating a bright pixel count of pixels having brightness exceeding a brightness threshold for each line of a binned interval; and
summing bright pixel counts of lines in the binned interval to generate a cumulative count of bright pixels.

3. The image processing method of claim 1, wherein determining whether the line in the target binned interval is in the side area of the image frame according to at least the bright pixel counts of the preceding line and the succeeding line in the target binned interval comprises:
computing a difference in the bright pixel counts between an (i+1)-th line and an (i−1)-th line of the target binned interval, i being an integer being an integer ranging from 1 to M; and
if the difference in the bright pixel counts between the (i+1)-th line and the (i−1)-th line is less than a count difference threshold, identifying an i-th line of the target binned interval as in the side area of the image frame.

4. The image processing method of claim 3, further comprising:
computing a difference in the bright pixel counts between an (j+1)-th line and an (j−1)-th line of the target binned interval, j being an integer ranging from 1 to M, and j and i being different integers; and
if the difference in the bright pixel counts between the (j+1)-th line and the (j−1)-th line exceeds the count difference threshold, identifying an j-th line of the target binned interval as in the central area of the image frame.

5. The image processing method of claim 3, further comprising:
identifying, from the target binned interval, a line closest to a boundary of the image frame that has a bright pixel count exceeding a line threshold as a rim; and
if an absolute difference of positions between the box edge and the rim exceeds a position difference threshold, updating the box edge according to the rim and the position difference threshold.

6. The image processing method of claim 5, further comprising:
if a pixel is located between the box edge and an intermediate line between the box edge and the rim, generating pixel data of the pixel in an output frame according to pixel data of the pixel in the image frame.

7. The image processing method of claim 5, further comprising:
if a pixel is located between the rim and an intermediate line between the box edge and the rim, generating pixel data of the pixel in an output frame according to a weighted sum of pixel data of the pixel in the image frame and minimum brightness data.

8. The image processing method of claim 7, wherein the pixel is located in i-th line of the target binned interval; and
the method further comprises:
computing a weight of the minimum brightness data according to brightness information of the pixel in the image frame and the difference in the bright pixel counts between the (i+1)-th line and the (i−1)-th line.

9. The image processing method of claim 7, wherein the difference in the bright pixel counts between the (i+1)-th line and the (i−1)-th line is stillness information of the pixel.

10. The image processing method of claim 5, further comprising:
if a pixel is located between the rim and a boundary of the side area, setting pixel data of the pixel in an output frame to minimum brightness data.

11. The image processing method of claim 1, wherein the N binned intervals are vertical.

12. The image processing method of claim 1, wherein N binned intervals are horizontal.

13. An image processor comprising:
a bright pixel counter to compute N cumulative counts of bright pixels in N binned intervals of an image frame, respectively, each binned interval comprising M lines, N being an integer greater than 1, M being an integer greater than 2;
a bin selection circuit coupled to the bright pixel counter to identify, from the N binned intervals, a target binned interval closest to a boundary of the image frame that has a cumulative count of bright pixels exceeding a bin threshold; and
a box edge circuit coupled to the bin selection circuit to determine whether a line in the target binned interval is in a side area of the image frame according to at least bright pixel counts of a preceding line and a succeeding line in the target binned interval, and select from the side area a line adjacent to a central area as a box edge.

14. The image processor of claim 13, wherein the bright pixel counter accumulates a bright pixel count of pixels having brightness exceeding a brightness threshold for each line of a binned interval, and sum bright pixel counts of lines in the binned interval to generate a cumulative count of bright pixels.

15. The image processor of claim 13, wherein the box edge circuit computes a difference in the bright pixel counts between an (i+1)-th line and an (i−1)-th line of the target binned interval, i being an integer greater than 1 and less than M, and if the difference in the bright pixel counts between the (i+1)-th line and the (i−1)-th line is less than a count difference threshold, identifies an i-th line of the target binned interval as in the side area of the image frame.

16. The image processor of claim 15, wherein the box edge circuit further computes a difference in the bright pixel counts between an (j+1)-th line and an (j−1)-th line of the target binned interval, j being an integer greater than 1 and less than M, and j and i being different integers, and if the difference in the bright pixel counts between the (j+1)-th line and the (j−1)-th line exceeds the count difference threshold, identifies an j-th line of the target binned interval as in the central area of the image frame.

17. The image processor of claim 15, further comprising:
a rim circuit coupled to the bin selection circuit to identify, from the target binned interval, a line closest to a boundary of the image frame that has a bright pixel count exceeding a line threshold as a rim, and;
wherein if an absolute difference of positions between the box edge and the rim exceeds a position difference threshold, the box edge circuit further updates the box edge according to the rim and the position difference threshold.

18. The image processor of claim 17, further comprising:
a motion compensation circuit coupled to the rim circuit and the box edge circuit to generate pixel data of a pixel in an output frame according to pixel data of the pixel in the image frame if the pixel is located between the box edge and an intermediate line between the box edge and the rim.

19. The image processor of claim 17, further comprising:
a motion compensation circuit coupled to the rim circuit and the box edge circuit to generate pixel data of the pixel in an output frame according to a weighted sum of pixel data of the pixel in the image frame and minimum brightness data if a pixel is located at a second sub-area of the side area defined by the rim and an intermediate line between the box edge and the rim.

20. The image processor of claim 18, wherein:
the pixel is located in i-th line of the target binned interval; and
the motion compensation circuit further computes a weight of the minimum brightness data according to brightness information of the pixel in the image frame and the difference in the bright pixel counts between the (i+1)-th line and the (i−1)-th line.

21. The image processor of claim 20, wherein the difference in the bright pixel counts between the (i+1)-th line and the (i−1)-th line is stillness information of the pixel.

22. The image processor of claim 17, further comprising:
a motion compensation circuit coupled to the rim circuit and the box edge circuit to set pixel data of the pixel in an output frame to minimum brightness data if a pixel is located at a third sub-area of the side area defined by the rim and a boundary of the side area.

23. The image processor of claim 13, wherein the N binned intervals are vertical.

24. The image processor of claim 13, wherein the N binned intervals are horizontal.
